(19) United States
(12) Patent Application Publication
(10) Pub. No.: US 2016/0215528 A1
(43) Pub. Date: Jul. 28, 2016

(54) Safety improved stop.

(71) Applicant: John Pedric, Thomtong, IL (US)

(72) Inventor: John Pedric, Thomtong, IL (US)

(21) Appl. No.: 15/002,506

(22) Filed: Jan. 21, 2016

Related U.S. Application Data
(60) Provisional application No. 62/106,790, filed on Jan. 23, 2015.

(51) Int. Cl. E05B 75/00

(52) U.S. Cl. CPC E05B 75/00

(57) ABSTRACT

A stopper that can be attached to a pair of handcuffs. The stopper making handcuffs safer for people wearing the handcuffs. The stopper being effective for providing an acceptable measurement of space between the handcuff and the wearer's limb.

### CROSS-REFERENCE TO RELATED APPLICATIONS

The present application claims the benefit of U.S. Provisional Patent Application No. 62/106,790, filed Jan. 23, 2015, the entirety of which is hereby incorporated by reference.

### BACKGROUND

Handcuffs have been used by police officers and in many amusement applications for many years. Mostly, these mechanisms are used to prevent a person, usually a prisoner, from being able to use his hands freely. Handcuffs traditionally are made with two rings, often made from steel. Each ring may comprise two segments that are hinged to allow each ring to open and close. One segment has an engaging mechanism that locks onto the other segment when the ring is closed. The rings are connected by a short chain. Each ring can fit over a person's wrists. The ring opening can be adjusted to suit differently sized wrists. One segment of a conventional handcuff ring includes a ratchet-like jaw section that allows the engaging mechanism to advance along the jaw-reducing the size of the opening as the jaw proceeds into the engagement mechanism.

Often handcuffs are placed on a prisoner's wrists by a method called speed cuffing. This speed cuffing involves quickly tapping the jaw section of the hinged ring of a handcuff against the prisoner's wrist and letting the jaw swing around the wrist and enter the engagement mechanism to capture the wrist in the ring. When using this method, the officer has little control of the swing momentum of the ring and must adjust the cuff after it's closed.

There is concern that forceful handcuffing can physically harm a person, such as a prisoner or one engaging in amusement activities. Police officers often hear prisoners complain that “my wrists hurt” or “I can't feel my fingers because the cuffs are too tight.” More and more, prisoners are filing civil lawsuit against police officers for violating their Fourth Amendment rights to be free from unreasonable searches and seizures. The cases are generally decided on the facts of each individual situation.

Being alert to the tightness of handcuffs can prevent injuries to peoples' wrists. Likewise by paying attention to the complaints of prisoners and monitoring their handcuffed wrists for visible signs of injury. When it comes to such monitoring, the circumstances of an arrest often poses certain limitations.

Prisoners will complain, and attempt to trick an officer into loosening the handcuff so the prisoner can escape. Additionally, once cuffs are tightened, and if overtightened, they would necessarily have to be removed to make them less tight. Speed cuffing by its very nature could prevent an officer from controlling the tightness of the handcuffs. The industry has implemented double locking handcuffs that include a second lock. The second lock stops the cuffs from being fastened more tightly than when first placed on the prisoner however it does nothing with respect to proper adjustment of the cuff around a person's wrist.

Information relevant to attempts to address these problems can be found in U.S. Pat. No. 6,997,020 B2. However, this reference suffers from one or more of the following disadvantages: the reference does not slide on nor provide any other simple attachment mechanism. Also, it is important that the reference could interfere with the handcuff closing against a limb. Also, the reference is not intended to be one use for all, it requires changing out parts for differently sized wrists.

There is a need in the industry for an apparatus that is easy to use, inexpensive, and assists people with properly attaching handcuffs while improving the handcuffed person's safety by preventing over tightening of the cuff around the person's wrist. There is a need for an apparatus suited to handcuffing that adds ease and efficiency to the current law enforcement adopted methods used for handcuffing. Such an apparatus should be capable of being used on existing handcuffs and be easily attachable.

### SUMMARY

The present invention is directed to an apparatus that satisfies these needs. An embodiment of the apparatus comprises a stopper that is attached to the jaw of handcuffs.

One embodiment of the present invention, which has been reduced to practice, is used to provide a stop gap to the handcuff ring, the jaw, as it is closed around a person's wrist. The device prevents over tightening and physical harm to the wrist of a person, such as a prisoner for example. Such an embodiment is suitable for regulating the use of handcuffs and comprises a stopper used on a pair of handcuffs. The stopper may have a shackle, or proximal, portion and a distal portion. The shackle portion may have an attaching mechanism attached to a jaw of the handcuffs. The attaching mechanism can include an adhesive that bonds the shackle portion to a segment of the handcuff. Alternatively, the attaching mechanism may include an aperture and/or a sleeve that may fit over a segment of the handcuff ring. Also, the attaching mechanism may be a secondary component connected to the stop and may be manufactured to be an integral part of handcuff. The distal end extends outward from the jaw to contact the wrist and is configured to prevent interference with the movement of the jaw. This is especially important when the handcuffs are being placed onto a person's wrist.

Another embodiment of the present invention comprises a stopper with a limb portion and a shackle portion. It includes an attaching member. The limb portion may be joined to the shackle portion essentially forming a single piece construction. The limb portion has at least one rest area that contacts a person's limb when the handcuffs are closed, such as when the handcuffs are speed cuffed around a wrist. The attaching member may be attachable and detachable to the jaw of the handcuff. This can be done in any effective way such as with the use of an adhesive strip or a slide-on tube or sleeve-like design that is stretchable.

Embodiments of the present invention offer many novel features. The stopper's limb portion and shackle portion can be made from a resilient material configured to provide sufficient rigidity to stop a closing jaw and yet yielding enough to prevent harm to the person's limb, such as silicone RTV to name one example. The stopper's attaching member could have an expandable tube capable of slidably attaching to the jaw, stretching it like a balloon placing it over or around a jaw of the handcuffs then sliding it into place. Also, the stopper's attaching member could be clipped to the jaw of a handcuff

Further embodiments can include stoppers with an attaching member that is attached to the jaw adhesively. Or the stopper wherein a measurement between the rest area and the attaching member acts as a guide for safely tightening of the handcuffs around a person's limb, this would be in line with the training that police officers receive regarding the two finger method. Another can be a stopper that is designed not to interfere with the operation of the handcuffs. Or a stopper that is integrally attached to the handcuffs at manufacturing.

An embodiment of the invention comprises a stopper that is configured to reduce an opening of a handcuff ring. It has an attachment edge fixed along an inner surface, which is often concave, of a curved segment of a handcuff ring. The fixing of the attachment edge can done by various means such as with an adhesive strip, a permanent manufactured design, or a stretch wrap to name a few examples. There is a stopper body extending inwards from the attachment edge and filling a portion of an arc of the inner surface adjacent to the attachment edge. It has a contact edge spanning endpoints of the attachment edge and terminating the stopper body. Generally, the contact edge is the portion of the invention that will touch the wrist of a person being cuffed. The stopper body can be made of a resilient material, have the contact edge contacting a wrist encircled by the handcuff ring, and the stopper body deforming to accommodate the wrist as the handcuff ring is closed.

Another embodiment of the present invention allows for it to be used without the user looking to assure safe tightening. It will work to stop a handcuff from closing around a wrist leaving a safer gap between handcuff and wrists according to a measurement that is traditionally taught in law enforcement training, e.g. the two finger gap test that is regularly taught to law enforcement officers in training. Under the two finger gap test, officer's are instructed that if they can insert two finger widths between the cuff and the person's wrist the cuffs are not too tight. The invention obviates the need to insert the fingers because it is made to stop at a gap that is substantially equivalent to the two finger width. Using the invention, the officer closes the handcuffs around a person's wrist and the gap is achieved automatically without the need for using the test.

### BRIEF DESCRIPTION OF THE SEVERAL VIEWS OF THE DRAWINGS

These and other features, aspects and advantages of the present invention will become better understood with regard to the following description, appended claims, and accompanying drawing where:

FIG. 1 shows a perspective view of an embodiment of the apparatus according to the present invention.

FIG. 2 shows a perspective view of another embodiment of the apparatus according to the present invention.

FIGS. 3A and 3B show a perspective view of a third embodiment of the apparatus according to the present invention.

FIG. 4 shows a perspective view of a fourth embodiment of the apparatus according to the present invention.

### DESCRIPTION

### Overview.

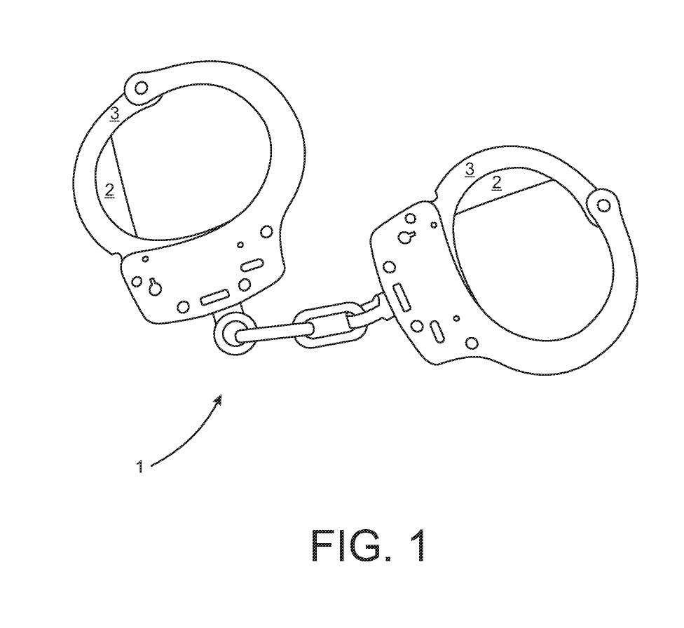

As shown in FIG. 1, an embodiment of the apparatus according to the present invention comprises a handcuff 1 with a stopper 2. The stopper 2 is attached to a ring segment 3, or jaw, of the handcuff 1.

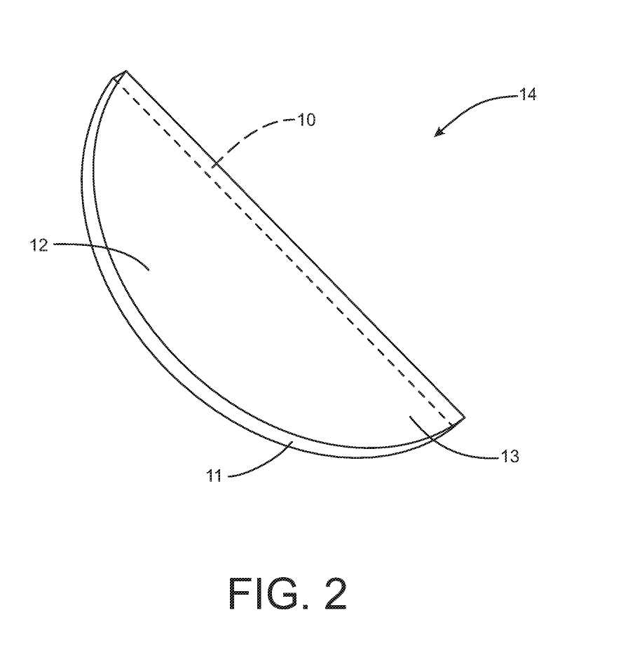

As shown in FIG. 2, another embodiment of the apparatus according to the present invention comprises a stopper 14. The stopper 14 has a rest area 10 that generally will be the area that comes into contact with a person's limb. The stopper 14 has an attaching member 11 which provides a mechanism for attaching the stopper 14 to the handcuff ring. The stopper 14 has a distal portion 13 (also called the limb portion) that lies against the limb of a person being cuffed. The stopper 14 has a shackle portion 12 that generally lies closest to the jaw of a handcuff to which the stopper 14 is attached, sometimes I refer to this as the shackle portion.

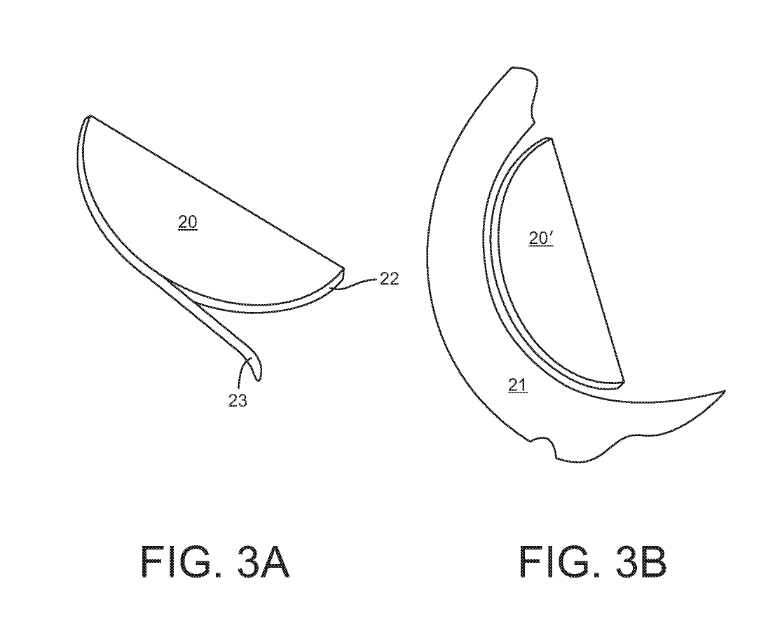

As shown in FIGS. 3A and 3B, a third embodiment of the apparatus according to the present invention comprises a jaw 21 of a handcuff to which a stopper 20′ is attached. The stopper 20 has an attaching member 22 which uses a protective strip 23 to uncover an adhesive section of the attaching member 22. The stopper 20′ can then be pressed against and attached to the jaw 21.

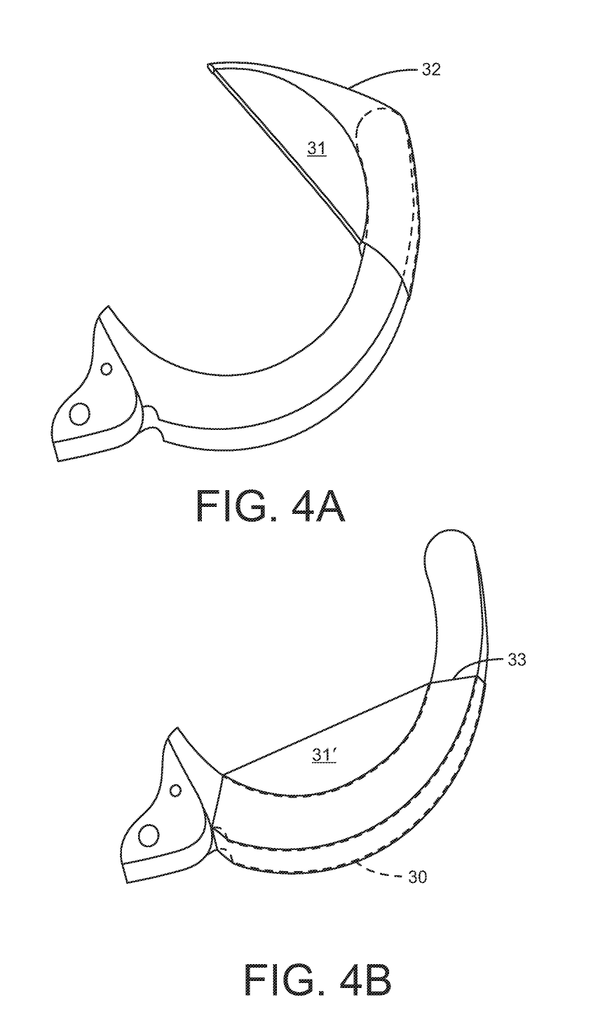

As shown in FIGS. 4A and 4B, a fourth embodiment of the apparatus according to the present invention comprises a stopper in a first position 31. There is an attaching member 32 that is stretchable, is tube shaped, and is attached to the stopper 31. The attaching member being stretched and wrapped 33 around a jaw of a handcuff 30. The stopper 31 slides over the jaw 30 and the attaching member 32 follows and retains the stopper 31′ on the jaw 30 by gripping (stretching over) the jaw 30. The stopper 31′, then, being slid into place and attached to the jaw of the handcuff 30.

Although the present invention has been described in considerable detail with the reference to certain preferred versions thereof, other versions are possible. For example, the resting area need not be one surface but could be a plurality of surfaces or the attaching mechanism could be magnetic. Therefore, the spirit and scope of the appended claims should not be limited to the description of the preferred versions contained herein.

Any element in a claim that does not explicitly state “means for” performing a specified function, or “step for” performing a specific function, is not to be interpreted as a “means” or “step” clause as specified in 35 U.S.C. §112, ¶6. In particular, the use of “step of” in the claims herein is not intended to invoke the provisions of 35 U.S.C. §112, ¶6.

What I claim is:

1. An apparatus suitable for regulating the use of handcuffs, the apparatus comprising:
a stopper;
a pair of handcuffs;
the stopper having a proximal portion;
the stopper having a distal portion;
the proximal portion having an attaching mechanism;
the attaching mechanism being attached to a jaw of the handcuffs;
the distal end extending outward from the jaw so as not to interfere with the movement of the jaw when being placed onto a person's wrist.

2. A stopper for use with handcuffs, the stopper comprising:
a limb portion;
a shackle portion;
an attaching member;
the limb portion being contiguously joined to the shackle portion;
the limb portion having a rest area;
the rest area contacting a person's limb when the handcuffs are closed around the person's limb;
the attaching member being attachable and detachable to a jaw of the handcuffs.

3. The stopper of claim 2 wherein the limb portion and the shackle portion are made from a material effective at providing rigidity to stop a closing jaw and yielding enough to prevent harm to the person's limb.

4. The stopper of claim 2 wherein the attaching member is an expandable tube capable of slidably attaching to the jaw.

5. The stopper of claim 2 wherein the attaching member is capable of clipably attaching to the jaw.

6. The stopper of claim 2 wherein the attaching member is attached to the jaw adhesively.

7. The stopper of claim 2 wherein a measurement between the rest area and the attaching member acts as a guide for safely tightening of the handcuffs around a person's limb.

8. The stopper of claim 2 wherein the stopper is designed not to interfere with the operation of the handcuffs.

9. The stopper of claim 2 wherein the stopper is integrally attached to the handcuffs.

10. A stopper configured to reduce an opening of a handcuff ring, the stopper comprising:
an attachment edge fixed along a concave inner surface of a curved segment of a handcuff ring;
a stopper body extending inwards from the attachment edge and filling a portion of an arc of the inner surface adjacent to the attachment edge; and
a contact edge spanning endpoints of the attachment edge and terminating the stopper body.

11. The stopper of claim 10, wherein the stopper body comprises a resilient material.

12. The stopper of claim 10, wherein the contact edge contacts a wrist encircled by the handcuff ring, and wherein the stopper body deforms to accommodate the wrist as the handcuff ring is closed.
